(19) United States
(12) Patent Application Publication
(10) Pub. No.: US 2017/0082418 A1
(43) Pub. Date: Mar. 23, 2017

(54) ELECTRONIC FABRIC FOR SHAPE MEASUREMENT

(71) Applicant: Figur8, Inc., Cambridge, MA (US)

(72) Inventor: Nan-Wei Gong, Cambridge, MA (US)

(21) Appl. No.: 15/271,863

(22) Filed: Sep. 21, 2016

Related U.S. Application Data
(60) Provisional application No. 62/221,590, filed on Sep. 21, 2015.

(51) Int. Cl. G01B 7/02; A41H 1/02

(52) U.S. Cl. CPC G01B 7/02; A41H 1/02

(57) ABSTRACT

Disclosed embodiments provide a way to measure the size of an object using an electronic fabric. Embodiments are particularly well suited for measuring human body parts such as legs, arms, feet, and the like. The measurements are acquired simply by wearing a garment comprised of the electronic fabric. Electrical properties such as resistance and capacitance are measured. These electrical properties are converted to distance measurements. The measurements are acquired by a local processor and then transmitted to a server, where the sizing information is converted to a higher level size, such as a dress size. Additionally, the sizing information can be converted to a clothing pattern to efficiently enable customized clothing based on size.

### RELATED APPLICATIONS

This application claims the benefit of U.S. provisional patent applications “Electronic Fabric for Shape Measurement” Ser. No. 62/221,590, filed Sep. 21, 2015. The foregoing application is hereby incorporated by reference in its entirety.

### FIELD OF ART

This application relates generally to systems for size measurement and more particularly to electronic fabric for measurement.

### BACKGROUND

The proper fit of clothing is essential for comfort, safety, and appearance, particularly for people who are in strenuous professions such as law enforcement, the military, athletics, and the like. Footwear is an item of clothing in which sizing is of utmost importance. For people who spend a lot of time on their feet, properly sized footwear is essential for getting through the day. Socks and shoes that are too tight can restrict circulation and cause pain. Similarly, socks and shoes that are too loose can cause uncomfortable rubbing or an increased likelihood of balance loss and falls. A properly sized shoe should have sufficient space in the front and a minimal amount of slipping in the heel. Foot sizes vary in width, and shoes that are too narrow are uncomfortable for a wearer. Hence, the width of the foot should always be considered when selecting footwear.

Since clothing and shoe size can change over time, a person's size may periodically need to be reassessed so that clothing and footwear can be properly updated to accommodate for any sizing changes in order to promote comfort and functionality. As people grow and age, their physical size changes. The most rapid change, of course, occurs in children, and their growth rate may be classified into two distinctive stages: a child tends to grow at a steady rate of about two to three inches per year between the ages of two and ten until the start of puberty, when a growth spurt triggers the development of a child into full adult size. This second stage generally occurs between the ages of nine and fifteen. Even after a child has developed into an adult, muscle mass, weight, and physical shape continue to change throughout adulthood for reasons such as pregnancy, diet, weight gain or loss, strength training, injury, and so on. In addition, people may have daily fluctuations in size due to diet, water retention, stress, altitude, and other factors.

Properly sized clothing and footwear is important for appearance, safety, and comfort. For specialized occupations such as firefighting, athletics, and construction work, properly fitting clothing and footwear is essential in order to successfully perform the needed tasks. As people's physical measurements change with age, shoe and clothing size is often reevaluated to ensure a proper fit and thus provide functionality and comfort in a variety of settings.

### SUMMARY

Properly sized clothing and footwear is important for comfort, safety, and appearance. Since size changes over time as people grow and age, it is desirable to periodically take measurements. Disclosed embodiments provide an electronic fabric for measurement. The electronic fabric can be integrated into articles of clothing, such as socks, pants, and shirts. The electronic fabric has a property of changing electrical properties, such as resistance and/or capacitance, when stretched. By determining the change in electrical properties when a wearer is wearing such a garment, physical dimensions can be ascertained. The physical dimensions can then be converted to a higher level size such as a shoe size, blouse size, or the like. An apparatus for measurement is disclosed comprising: an electronic component incorporated with a fabric, where the electronic component includes a plurality of flexible electrically-conductive threads that comprise the fabric; insulating threads incorporated with the flexible electrically-conductive threads, where the insulating threads also comprise the fabric and insulate a signal from a first electrically-conductive thread from other threads in the plurality of flexible electrically-conductive threads; and a processing module, coupled to the flexible electrically-conductive threads that obtains sizing dimension information using the plurality of flexible electrically-conductive threads.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 shows example threads in a sensing fabric.

FIG. 2 shows example non-extension lines with resistive connection.

FIG. 3 is an illustration of capacitive sensing fabric.

FIG. 4 shows example segmented capacitance usage.

FIG. 5 illustrates a set of resistive threads and varying diameter body portions.

FIG. 6A shows a processing module for resistive sensing.

FIG. 6B shows generation of higher level sizing information.

FIG. 7 illustrates sizing dimension information capture and conversion.

FIG. 8 shows a garment for detecting sizing.

FIG. 9 is a flow diagram for analysis of sizing information.

FIG. 10 is a system for analyzing sizing information.

### DETAILED DESCRIPTION

Disclosed embodiments provide a way to measure the size of an object using an electronic fabric, particularly the measurement of human body parts such as legs, arms, feet, and the like. The measurements can be acquired by simply wearing a garment comprised of the electronic fabric. Electrical properties such as resistance and/or capacitance are measured. These properties are converted to distance measurements. The measurements are acquired by a local processor and can then be transmitted to a server where the sizing information can be converted to a higher level size, such as a dress size. Alternatively, the sizing information can be converted to a clothing pattern to efficiently enable customized clothing based on size.

Another application of the disclosed embodiments is the measuring of size over time. The sizing information can be acquired from a local processor and can then be uploaded by a near field communication system, such as a Bluetooth to a mobile phone, for data collection and analysis. The monitoring of size over time can provide useful medical information which can have applications in the field of physical health and wellness. For example, an undergarment equipped with a measuring garment integrated into the waistband can provide daily updates on waist size. The garment can then transmit results to a user's mobile phone. The mobile phone can execute a program (app) to track waist size and alert the user if the waist size exceeds a predetermined level, which can, in turn, alert the user to cut back on caloric intake. Another application of periodic measurement can pertain to athletes. In such an embodiment, bodybuilders, weight lifters, runners or other athletes can easily track size increases and decreases as they train.

In other embodiments, the quick assessment of size in an electronic form allows for unprecedented capabilities in custom-manufactured clothing. For example, a user can use a measuring garment to quickly obtain detailed foot measurements and transmit the measurements to an online shoe store. Customized shoes can be manufactured to the specifications of the measurements provided by the user. Alternatively, the shoe store can search a product database to select existing footwear that most closely matches the detailed size information provided by the measuring garment. These, among others, are just a few applications for the use of measuring clothing and footwear size using an electronic fabric.

A given object can stretch, shrink, twist, bulge, or otherwise deform. Deformation can be elastic, which is reversible, and plastic, which is irreversible. How the object deforms, such as whether it stretches, shrinks, hardens, breaks, etc., is dependent on the material or materials that make up the object. The result of deformation or strain of the given object is a change in the shape or size of the object. The changes in size can include the length, width, and height, whether alone or in combination. The deformation of the object can result from an applied force such as tensile or compressive forces, a change in temperature such as heating or cooling, etc. Other sources of deformation of an object due to force include torsion, shear, bending, etc. Deformation of the object due to temperature deltas can result from the material properties of the object that is deformed. These latter deformations can result from point vacancies, dislocations, twins, and faults in the materials of the object. Temperature deformations have been noted in solids, whether the solids are crystalline or not.

Threads, yarns, and so on to be used for an electronic fabric for measurement can possess the desirable property of elastic deformation. Unlike plastic deformation which is irreversible, a material that exhibits elastic deformation can return to its original size and shape. Elastic deformation can be linear over a range of stress and strain values. While a given material remains in its linear range, the linear elastic deformation is described by Hooke's Law, where the applied stress equals Young's constant multiplied by strain. The linear range of the material ends when the material reaches its yield strength. Beyond the yield strength, the material experiences plastic nonlinear response to the applied strain, where the material can experience strain hardening, necking, and ultimately fracture.

Materials such as polymers that can be used to make thread, yarn, etc., for an electronic fabric for measurement can possess nonlinear elastic deformation properties. Various techniques can be employed to compensate for the nonlinear deformation properties. When a value for a physical parameter such as resistance or capacitance is determined for the deformation of a polymer, then the physical parameter can be used to determine stress, strain, stretch, and so on. One technique that can be used is a lookup table. For a given value of resistance, for example, the lookup table can be used to determine deformation, such as an amount of stretch. In another technique, a reference with known linear elastic deformation characteristics can be used to determine deformation of the nonlinear elastic deformation polymer. In a further technique, physical parameter values that are obtained from the deformation of a material can be calibrated against physical parameter values of a known linear elastic deformation material.

The various materials such as polymers that can be included in the threads, yarns, etc. that can be incorporated into an electronic fabric for measurement can be applied to other application areas in which measurement of one or more portions of a body can provide information relevant to the application areas. These additional application areas can include personal health, activity tracking, athletics and training, physical therapy, rehabilitation therapy, post-operation tracking, and so on. These applications can use the measurement capabilities of the electronic fabric to monitor one's health, track activity and attainment of activity goals, monitor muscle movement, determine training outcomes, measure therapy progress, etc. In embodiments, a garment formed from the electronic fabric can be worn on or applied to a portion of a body. The garment can include a shirt, a cuff, an arm band, a waist band, shorts, pants, a leg band, socks, undergarments, etc. The garment can be donned by a user, an assistant, a trainer, by a medical professional, and so on. In embodiments, an interface connector can be coupled to the garment and can facilitate the attachment of a processing module to the measuring garment.

The measurements that can be obtained from the electronic fabric for measurement can be based on a circumference of a portion of a body. Such a measurement can include the circumference of an arm or a leg, and can be used to determine a size of the limb, a change in size (size delta) of the limb, and so on. The size delta for the limb can be used to track edema. The measurements can include a size such as a length, a width, a thickness, and so on. The measurements can include a distance between landmarks of a body or portion of a body, such as the distance between a shoulder and an elbow, and elbow and a wrist, a hip and a knee, a knee and an ankle, etc. The measurements for sizing can be used for preoperative evaluations, postoperative tracking, sizing of medical appliances, etc.

Other measurements can also be obtained from the electronic fabric. The other measurements can include measuring linear displacement or elongation of a portion of a body. The elongation that can be measured and/or inferred can be based on a changing angle of the portion of the body. The portion of the body can include an elbow, a knee, an ankle, a neck, a shoulder, a hip, etc. The measuring of an angle can be used for such applications as postoperative physical therapy to determine progress relating to range of motion of the portion of the body. The measuring of the size and the angle relating to range of motion of the portion of the body can be used to evaluate progress toward postoperative physical therapy goals, to identify excess swelling, to fit a medical device such as a brace or cast, and so on.

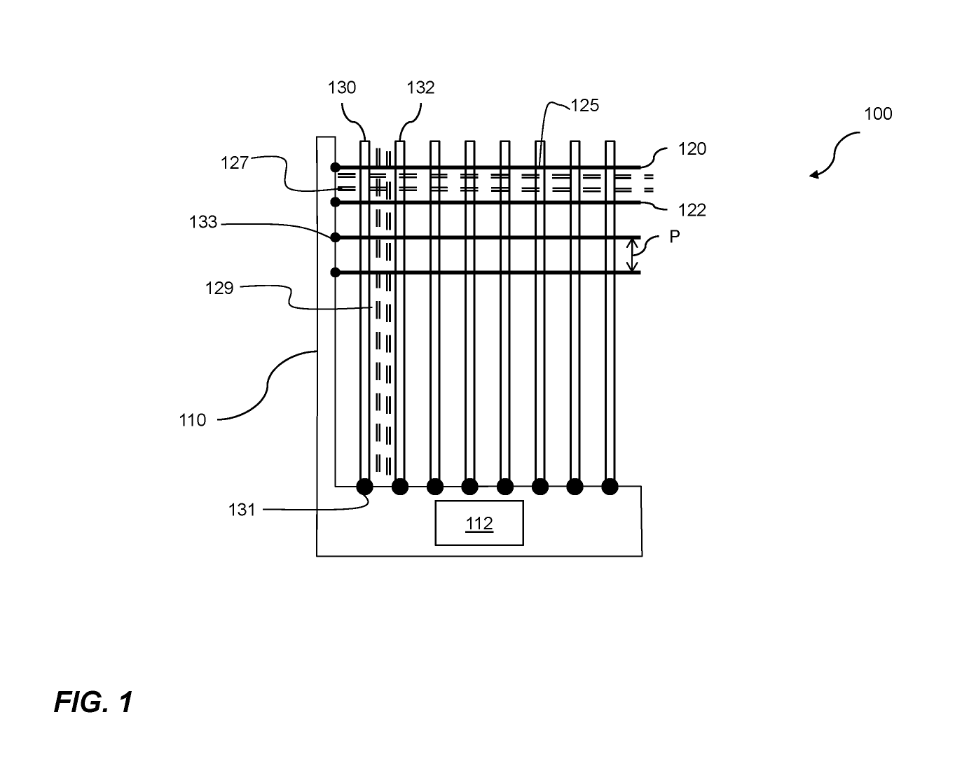

FIG. 1 shows example threads in a sensing fabric. The example 100 describes an apparatus for measurement. The fabric can utilize a flexible electrically-conductive thread that changes resistance when stretched. In embodiments, the fabric is stretchable in a single direction. The amount of resistance change as a function of distance can be computed or empirically determined. The fabric can include a plurality of horizontal flexible electrically-conductive threads, shown in the example as the horizontal flexible electrically-conductive threads 120 and 122, and a plurality of vertical flexible electrically-conductive threads, shown in the example as the vertical electrically-conductive threads 130 and 132. In between the electrically conductive threads can be a plurality of standard, non-conducting, insulating threads such as cotton threads, polyester threads, or the like, shown in the example as the non-conducting threads 127 and 129. The insulating threads 127 and 129 can provide for electrical insulation between the plurality of electrically-conductive threads. For example, the conductive threads can be spaced apart by a pitch P. In some embodiments, P ranges from ten millimeters to three centimeters. The fabric in between the conductive threads can be comprised of insulating (non-conducting) threads.

A plurality of resistive threads can run in two dimensions. The two dimensions can be substantially at 90-degrees to one another. In some embodiments, only the horizontal direction uses electrically-conductive threads. In other embodiments, only the vertical direction includes electrically-conductive threads. In embodiments that have both horizontally and vertically oriented electrically-conductive threads, an insulating material (not shown) is configured and disposed to prevent electrical contact between horizontally and vertically oriented electrically-conductive threads at the crossover points, shown as the crossover point 125 in the example 100.

The electrically-conducting threads 120, 122, 130, and 132, along with the non-conducting threads 127 and 129, comprise a mesh. The mesh is attached to a garment frame 110. The garment frame 110 can be comprised of additional fabric, rubber, plastic, or other suitable material. The garment frame 110 can include an internal bus to provide signals from the electrical contacts 131 and 133 to a processing module 112, such that the electrical signals from the electrically-conductive threads can be measured. Since the internal bus might need to provide a relatively large number of signals, a serializing bus protocol is utilized in some embodiments. In embodiments, the bus protocol includes, but is not limited to, I2C, serial peripheral interface (SPI), IEEE P1451, or another suitable protocol. The bus can further include additional circuitry such as multiplexers and/or sensor selection circuits to acquire the measurement of a particular thread or capacitive element (not shown).

The processing module 112 can include a processor, memory, a plurality of pickups for measuring an electrical property such as resistance or capacitance, and a signal generator for generating direct current and/or alternating current active signals to facilitate the measurements. The active signals can sweep through a range of frequencies in order to determine the capacitance values. Thus, in some embodiments, a frequency sweep is used to cover a range of frequencies. For example, the frequency can sweep from 1,000 hertz to 10,000 hertz, with capacitance measurements taken at 1,000 hz intervals. Additionally, the processing module can include an interface port, such as a micro-USB port, a Bluetooth interface, and/or one or more buttons. The processing module can be detachable from the fabric. In some embodiments, the processing module is removable from the garment frame 110. In such embodiments, the processing module is simply added to the garment frame for the purpose of measurement, and then removed when the measurement is complete. An example use includes socks with electrically-conductive threads. Since socks are a personal item, it is preferable that each user has his or her own socks for computing foot measurements (i.e. the measuring garment). However, the shoe store might possess the processing module. In this case, a customer can bring his or her own measuring socks to a footwear retailer, where the retailer can then attach the processing module to perform the measurement. In this way, the cost of the processing module need only be incurred by the retailer, and the garment portion can be given out to customers at a lesser cost since the processing module is not included in each pair of measuring socks. In such an embodiment, an interface connector facilitates the attachment of the processing module to the measuring garment. Another example use includes a brassiere with electrically-conductive threads. As was the case for socks, a brassiere is a personal item, so each user can bring her own measuring brassiere for computing relevant measurements. Other undergarments for measurement can be imagined such as a girdle, close-fitting undershorts, etc. Thus, the example 100 can include an electronic component incorporated with a fabric, where the electronic component can include a plurality of flexible electrically-conductive threads that comprise the fabric and insulating threads incorporated with the electrically-conductive threads, where the insulating threads can also comprise the fabric and insulate a signal from a first electrically-conductive thread from other threads in the plurality of electrically-conductive threads.

The processing module 112, coupled to the electrically-conductive threads, can obtain sizing dimension information using the plurality of electrically-conductive threads. The sizing dimension information can be derived from a measurement of electrical properties. The electrically-conductive threads can be used to determine the sizing dimension information based on resistance. The electrically conductive threads can be stretchable and resistance of the electrically conductive threads can change as the electrically conductive threads are stretched. For example, a conductive thread of 27 centimeters might have a resistance of 250 k ohms in an original (un-stretched) position, a resistance of 300 k ohms when stretched an additional three centimeters, a resistance of 450 k ohms when stretched an additional five centimeters, and so on. From this relationship, a mathematical formula and/or empirical data along with interpolation can be used to ascertain a size for a given resistance.

The fabric can be secured to an existing garment. For example, a band comprised of a fabric including electrically-conductive threads can be secured to the waistband of sweatpants to enable a waist measurement. In such an embodiment, ordinary articles of clothing are converted to smart, wearable, technology based clothing by sewing, or by fastening a measuring band to the ordinary article of clothing. The measuring band can be comprised of fabric containing a plurality of electrically-conductive threads. The measuring band can further comprise a processing element or an interface port for connection of a processing element when a measurement is desired. Further lines of non-extension can be included within the fabric. In some embodiments, a physical coupling device that limits size changes within a portion of the fabric is included, such as a strap, buttons, or a zipper. The physical coupling device can limit a portion of the fabric to facilitate measurement using another portion of the fabric.

The plurality of electrically-conductive threads can comprise a polymer. In some embodiments, the electrically-conductive thread comprises a base thread composed of cotton, nylon, or polyester. The base thread is then coated with a conductive film. In embodiments, the coating includes an alloy comprising silver, copper, tin, and/or nickel. In other embodiments, the electrically-conductive thread is comprised of carbon-impregnated polyolefin. In yet other embodiments, the electrically-conductive thread is comprised of a non-conductive elastomeric polymer matrix filled with electrically conductive particles. Embodiments are not limited to the aforementioned materials. Any flexible electrically-conductive fabric that measurably changes resistance when under tension can be used to construct a measuring garment in accordance with the embodiments disclosed herein.

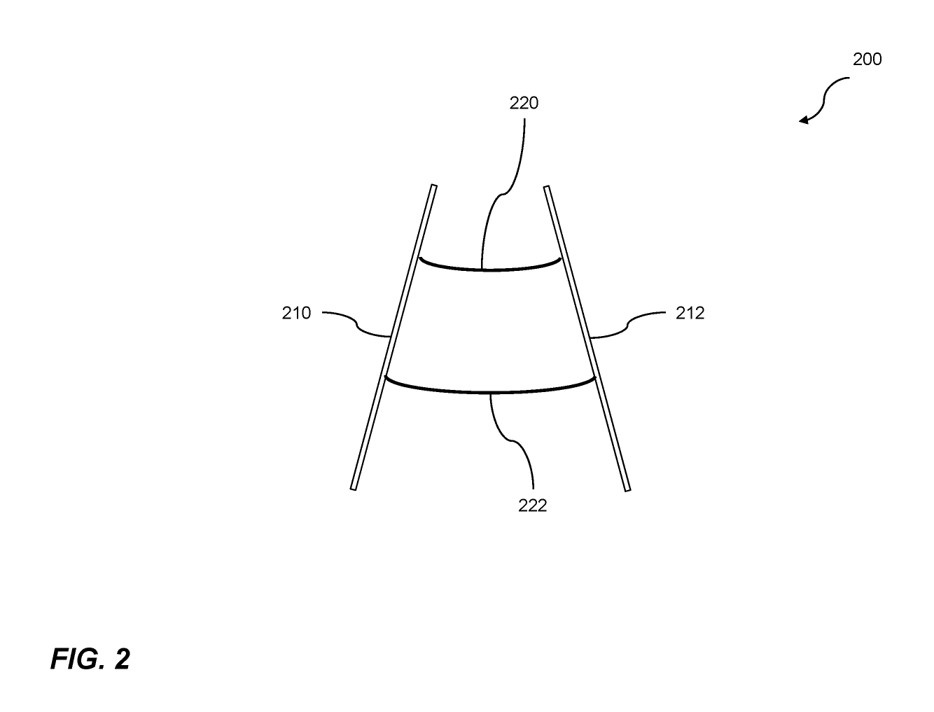

FIG. 2 shows example non-extension lines with resistive connection. In the example 200, the non-extension lines 210 and 212 can be comprised of insulating fabric. The non-extension lines 210 and 212 can correspond to a long limb such as a lower leg, upper leg, upper arm, or lower arm. The lines of non-extension can be crosswise with respect to the plurality of electrically-conductive threads. The electrically-conductive threads 220 and 222 can be disposed between the non-extension lines. As the lines of non-extension are positioned further apart from each other, the resistance measured across the threads 220 and 222 changes. The resistance values can be used to derive a length, which can in turn be converted into a higher level size, such as a shoe size, waist size, or the like. Thus, the sizing dimension information can be determined based on stretching of the plurality of electrically-conductive threads. The first electrically-conductive thread 220 can comprise a first electrically-conductive thread that stretches a first amount. The first amount can correspond to a first resistance change. Alternatively, the first amount can correspond to a first resistance value. The example 200 can further comprise a second resistive thread 222 from the plurality of electrically-conductive threads. The second resistive thread can stretch a second amount. The second amount can correspond to a second resistance change. Alternatively, the second amount can correspond to a second resistance value. The sizing dimension information can include data on the first amount and the second amount. The data allows a profile of a shape to be rendered. For example, the human leg tends to be wider across the hip and quadriceps area and narrower by the knee. By using multiple electrically-conductive threads that are of varying resistance when stretched, an assessment of a complex shape such as a human limb can be derived.

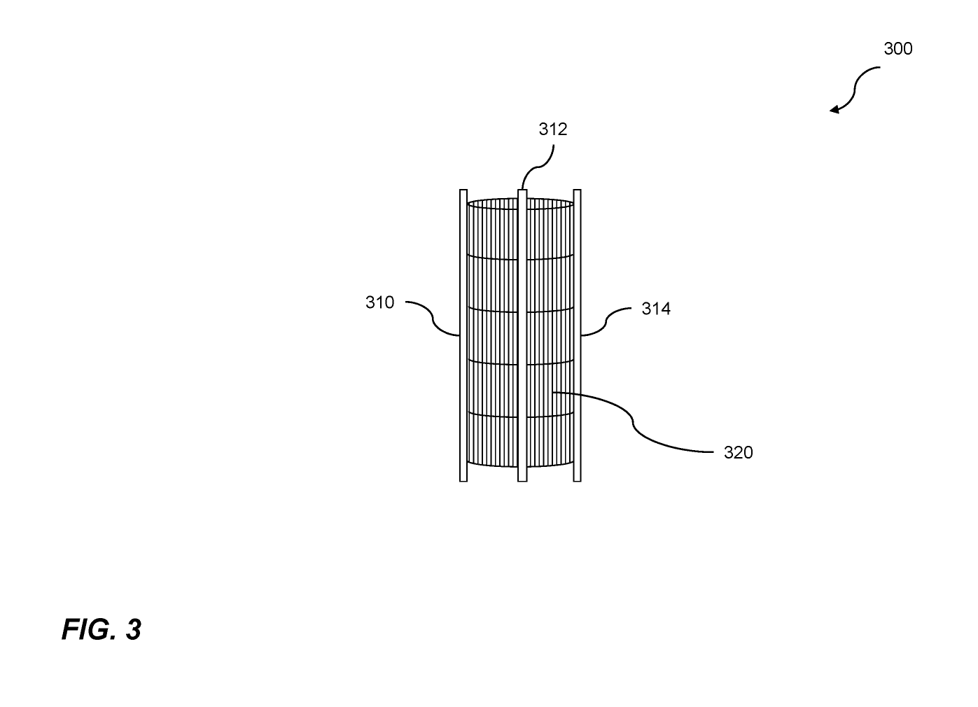

FIG. 3 is an illustration of capacitive sensing fabric. In the illustration 300, a plurality of plates 310, 312, and 314 are integrated into a conductive fabric 320. The electrically conductive threads can be used to determine the sizing dimension information based on capacitance. In this embodiment, the electrically conductive fabric 320 is flexible (i.e. stretchable), but does not necessarily need to measurably change resistance when stretched. The fabric can contain a plurality of electrically-conductive threads, and the plurality of electrically-conductive threads can be parallel to one another within the fabric. The plurality of electrically-conductive threads can be all directed in substantially a same direction. The single direction, along with the fabric that is stretchable, can be along an axis containing the plurality of electrically-conductive threads.

In embodiments, distance is ascertained between adjacent plates by measuring the capacitance between the adjacent plates. The fabric between the electrically conductive threads can be stretchable and the capacitance can change as the fabric between the electrically conductive threads is stretched. As the fabric is stretched over a body part, the distance between adjacent plates increases. While only three plates are shown in FIG. 3, in embodiments, there can be many plates within the fabric, such that the spacing of the plates can range from about five millimeters to about ten millimeters. A processing module can further include a generating module, which is configured and disposed to generate an alternating current signal at one or more frequencies to enable a capacitance measurement. As the capacitance changes as a function of distance between the plates, the distance between adjacent plates can be determined based on the measured capacitance value. The fabric can comprise a tube of substantially uniform diameter. The distance around the entire tube can be computed by summing the distances between each of the adjacent plates. Thus, in the illustration 300, the distance around the mesh can be computed by summing the distance between the plate 310 and the plate 312, the distance between the plate 312 and the plate 314, and the distance between the plate 314 and the plate 310.

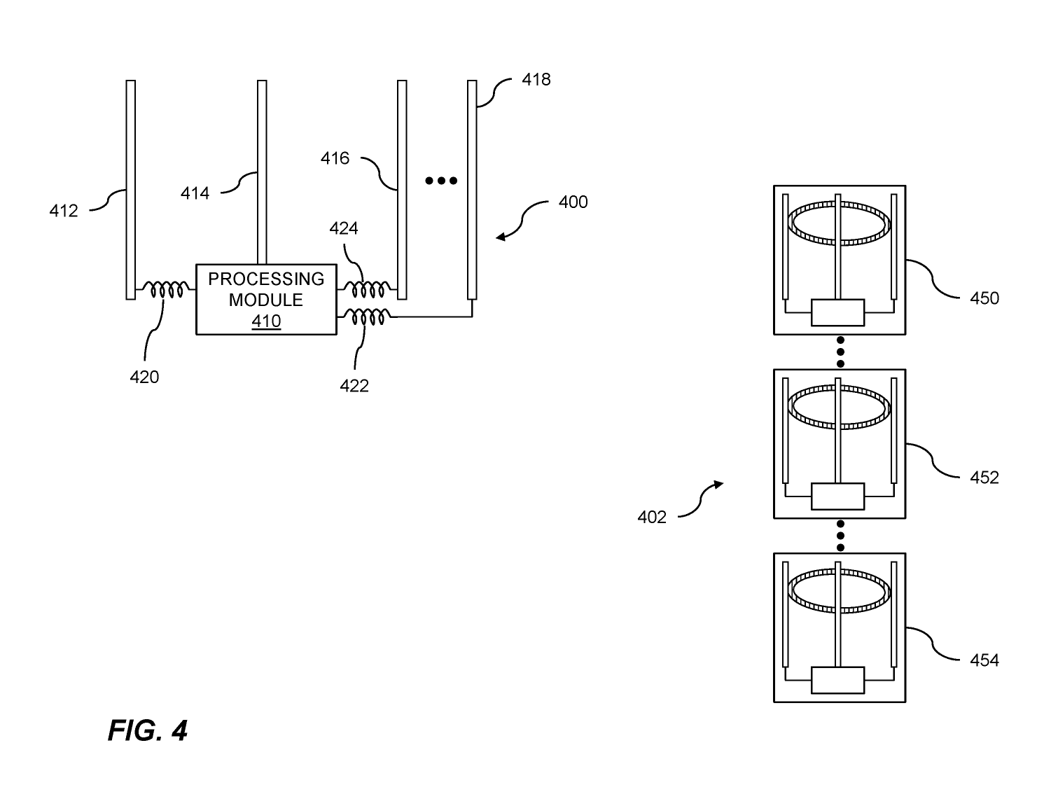

FIG. 4 shows example segmented capacitance usage. The electrically conductive threads can be separated into segments and capacitance values can be collected from the segments. Human body parts typically have a complex shape of varying sizes throughout. For example, a leg is typically widest at the midpoint of the quadriceps and then narrows at the knee, widens again at the calf, and comes to its narrowest point at the ankle. The use of multiple segments allows for measurement of such complex shapes. FIG. 4 shows a block diagram of a capacitive segment 400. The capacitive segment 400 can comprise a plurality of plates, indicated as the plates 412, 414, 416, and 418. The plates can be comprised of a conductive material such as an aluminum, copper, or other strip material. Furthermore, stretchable fabric segments such as the fabric segments 420, 422, and 424 can be disposed between adjacent segments. Each plate is connected to the stretchable fabric. The capacitive segment 400 can further include a processing module 410. The processing module 410 can provide active signals to the plurality of electrically-conductive threads in order to determine the capacitance values. In embodiments, the processing module 410 includes a generating module for generating alternating current signals of varying frequency for taking capacitance measurements.

In some embodiments, the capacitive measurement is performed by first charging a capacitor by applying an active signal, and then measuring a first voltage across the capacitor, followed by stopping the active signal, and then measuring a second voltage across the capacitor at a predetermined time after cessation of the active signal. The theoretical capacitance is based on a time constant TC and given by the following formula:

TC=R×C

where TC is the time constant, R is a resistance value, and C is a capacitance value. Starting from discharge, the voltage at one time constant is approximately 63-percent of the charging voltage. In embodiments, the time constant is determined by periodic voltage measurement, and the resistance is also measured. Once the time constant and resistance are determined, the capacitance can then be computed. The processing module 410 can perform these measurements. Other capacitive measurement techniques can also be used in place of or in conjunction with the aforementioned method.

FIG. 4 shows a multi-segment capacitive fabric tube structure 402. The multi-segment capacitive fabric tube structure 402 comprises a first segment 450, a second segment 452, and a third segment 454. Each segment is similar to the capacitive segment 400 in that they can comprise a plurality of plates, stretchable fabric segments, and a processing module. A segment identification number can be associated with each processing module. Thus, when a processing module reports measurement results, the results are associated to a segment by the segment identification number (segment ID). The processing modules of each segment can have a wireless communication interface such as a Bluetooth or Bluetooth Low Energy (BLE) module to transmit capacitance results to a nearby computer or mobile device which can then arrange the measured dimensions based on segment ID to reconstruct a shape profile of the body part that was measured.

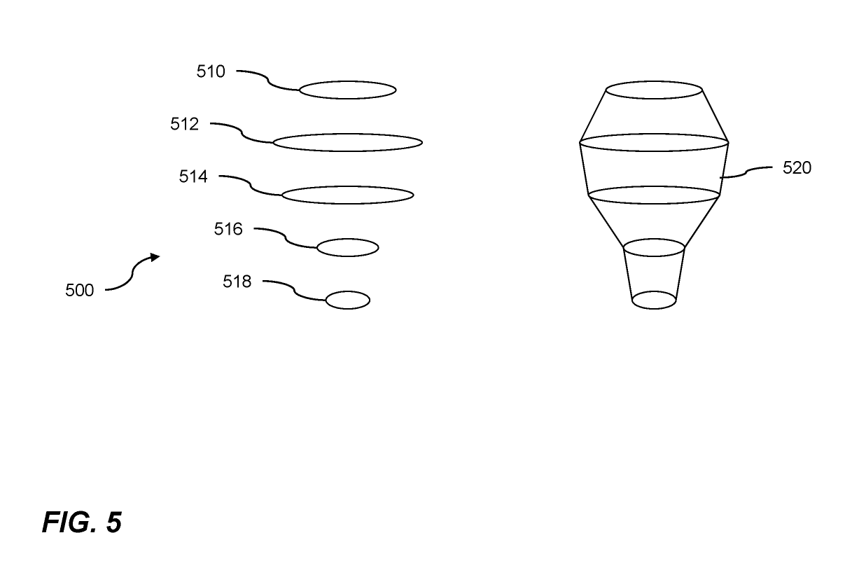

FIG. 5 illustrates a set of resistive threads 500 and varying diameter body portions. The set of threads 500 includes the threads 510, 512, 514, 516, and 518. In practice, a measuring garment can comprise hundreds of electrically-conductive threads that vary in electrical resistance when stretched. The threads 510-518 can be of different lengths to accommodate the complex shape of a human limb. The threads 510-518 can be part of a measuring fabric. Note that while the threads 510-518 are illustrated in FIG. 5 as loops, there is a connector for each thread (not shown) to interface to a processing module. Hence, each thread is an open loop across which a resistive measurement is taken. The fabric can comprise a conical tube 520. The conical tube 520 can be sized to evaluate a dimension from a person. The resistance measurements can be converted to distance measurements, and the distance measurements can in turn be converted to a size. Some embodiments use a combination of resistance measurements and capacitive measurements to compute sizing information.

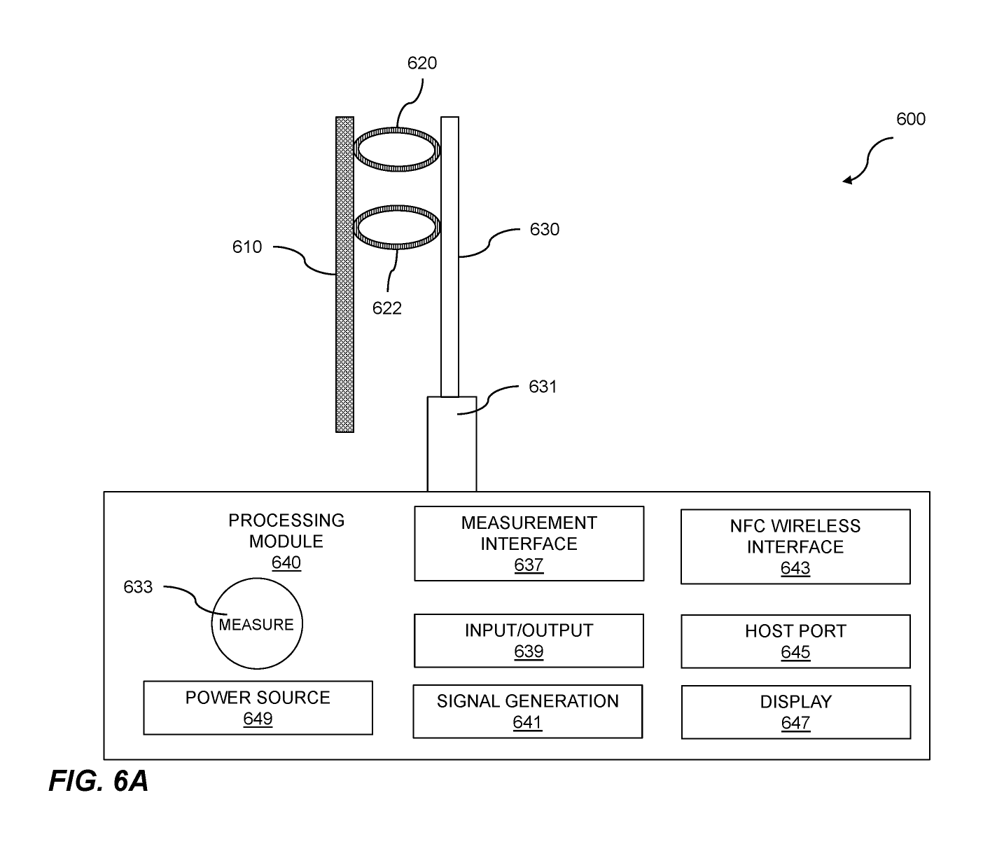

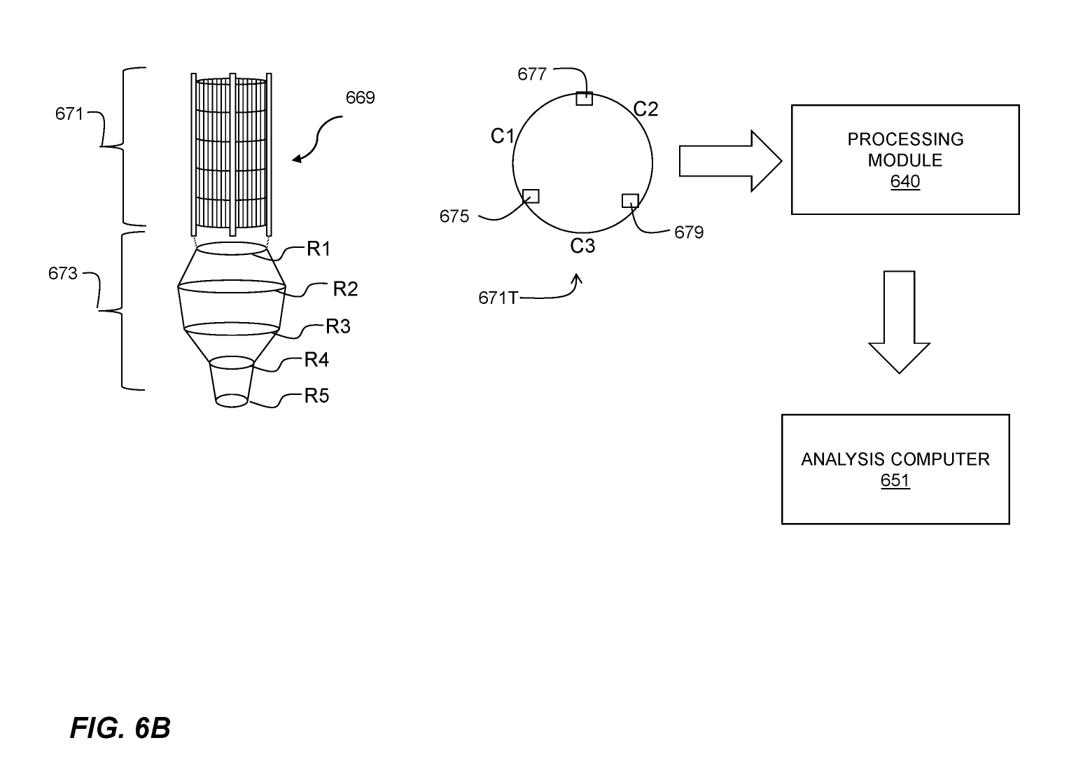

FIG. 6A shows a processing module for resistive sensing. The diagram 600 shows some electrically-conductive variable resistance threads 620 and 622 attached to the lines of non-extension 610 and 630. The line of non-extension 630 can also contain an electrical bus that routes signals to a connector 631. A processing module 640 can be attachable to the connector 631. This allows the processing module 640 to be easily removed from the measuring garment so that the measuring garment can be washed. The removable feature of the processing module 640 can also facilitate the use of a single processing module to collect measurements from multiple measuring garments simply by connecting the processing module to the measuring garment using the connector 631.

In some embodiments, the processing module 640 also includes a button 633. The button 633 can be a momentary push button to signal the start of a measurement. In some embodiments, the measurement starts at a predetermined time after the measure button is pressed, in order to give the threads a chance to settle in position and reduce variability in the measurement. For example, upon pressing the measure button 633, the processing module 640 can start a fifteen second timer. After the timer expires, the measurement data can then be acquired. The processing module 640 can further include a measurement interface 637, including the circuitry for measuring resistance and/or capacitance. The processing module 640 can further include an input/output (I/O) module 639 for receiving input signals and producing output signals. The processing module 640 can further include a signal generation module 641 for generating direct current (DC) and/or alternating current (AC) signals to facilitate resistance and/or capacitance measurements.

The processing module 640 also includes, in some embodiments, a near field communication (NFC) wireless interface 643. The NFC wireless interface 643 can include a Bluetooth interface, Bluetooth Low Energy (BLE) interface, Zigbee™ interface, or another suitable NFC interface. The NFC wireless interface can be used to transmit raw data to a nearby computer, tablet, or another mobile device for further processing and analysis. The processing module 640 also includes, in some embodiments, a host port 645. The host port can include a USB port or another hardware interface such that a host computer can be directly attached to the processing module. In some embodiments, the setup of the processing module and transmission of measurement results is sent through the host port 645. In some embodiments, power to the processing module 640 is also supplied through the host port 645. The processing module 640 can also include a display 647. In embodiments, the display 647 comprises a small LCD screen, e-ink display, or another suitable display. The display 647 can be used to output sizing and/or diagnostic information, such that the information can be read directly from the measuring garment. The processing module 640 can also include, in some embodiments, a power source 649, which can include a rechargeable battery, a button cell battery, a lithium ion battery, or another suitable power source to power the processing module 640.

FIG. 6B shows generation of higher level sizing information. A processing module 640 can gather the sizing dimension information to generate higher level sizing information. In FIG. 6B, a measuring garment 669 is shown. The measuring garment 669 is a resistive-capacitive measuring garment, as it comprises a capacitive measuring section 671 and a resistive measuring section 673. The capacitive measuring section 671 is shown in top-down view as the illustration 671T. As can be seen in the top-down view illustration 671T, the capacitive measuring section comprises three plates, plates 675, 677, and 679. A corresponding capacitance value is measured for each adjacent pair. The capacitance value C1 is the capacitance between the plate 675 and the plate 677, the capacitance value C2 is the capacitance between the plate 679 and the plate 677, and the capacitance value C3 is the capacitance between the plate 675 and the plate 679.

The resistive measuring section 673 of the measuring garment 669 comprises a plurality of resistive threads, each generating a resistance value, values R1, R2, R3, R4, and R5. The capacitance values C1-C3 and the resistance values R1-R5 are acquired by the processing module 640. In embodiments, these values are then sent to an analysis computer 651 for further processing. The processing module 640 can send the electrical measurements in a packet that includes the capacitance values for each capacitive segment, an identification number for the segment, each resistance value, and an identification number for each resistance value to indicate to which thread the resistance value pertains.

The analysis computer 651, upon receiving the information, can use a combination of mathematical formulas and/or empirical data based on lookup tables to generate distance information for each electrical measurement. The three capacitance values C1-C3 are converted to distance measurements (i.e. sizing dimension information). Those distance measurements are summed to compute a total circumferential distance of the capacitive segment. The computed distances are then converted into a high level size information. The sizing dimension information can include a length, a width, or a spacing. For example, foot measurement data including 14 inches in length and a maximum width of 4.5 inches can translate to a size 14D shoe size. In some embodiments, the analysis computer transmits the high level size information back to the processing module 640 for display on the local display, such as the display 647 as shown previously in FIG. 6A.

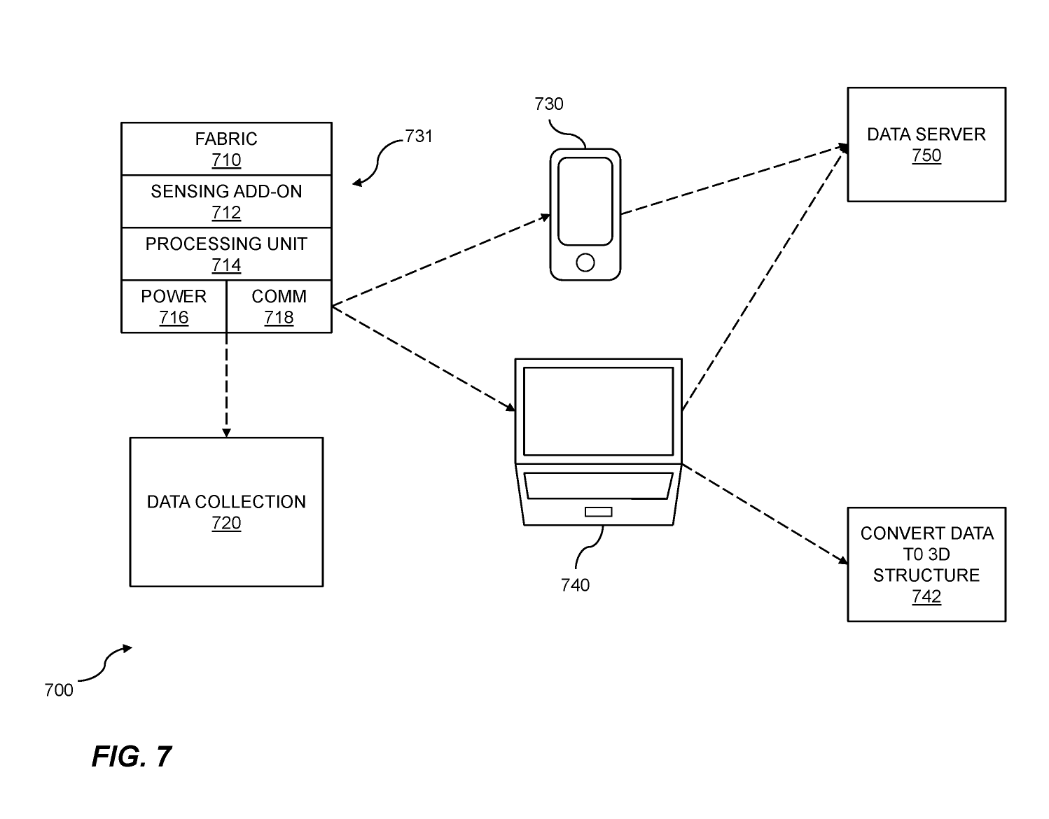

FIG. 7 illustrates sizing dimension information capture and conversion. The diagram 700 includes a local module 731 which includes the fabric 710. The fabric 710 includes one or more electrically-conductive threads, and can also include plates, such as the plates used in capacitive measuring segments. The local module 731 further includes a sensing add-on 712 which can be used to collect measurement data. The local module 731 further includes a processing unit 714 which gathers the measurement data and sends it via a communications interface 718. An onboard power supply 716, such as a battery, provides power for the local module 731. The measurement data can be sent to a data collection module 720. In embodiments, the data collection module 720 includes a USB flash drive. The data collection module 720 can interface to the local module 731 using a host port. The data can also be sent via the communications interface 718 to a mobile device 730 and/or an analysis computer 740 via a wireless communication protocol such as Bluetooth, Bluetooth Low Energy (BLE), Zigbee, or the like. In embodiments, the processing unit 714 employs power management wherein the sizing dimension information is collected during a lower power mode and sizing dimension information is transmitted during a higher power mode. The data can then be sent to a data server 750 for storage and subsequent retrieval. The data server 750 can store the sizing information along with a customer profile. This enables data-rich features such as customized advertisements to users based on their size. For example, advertisements showing styles and brands of clothing that have sizes that match a certain customer profile can be served to the specific customer. The data can also be converted to a 3D structure 742. The 3D structure can include a clothing pattern, an article of clothing, a 3D printed model, or another 3D data representation.

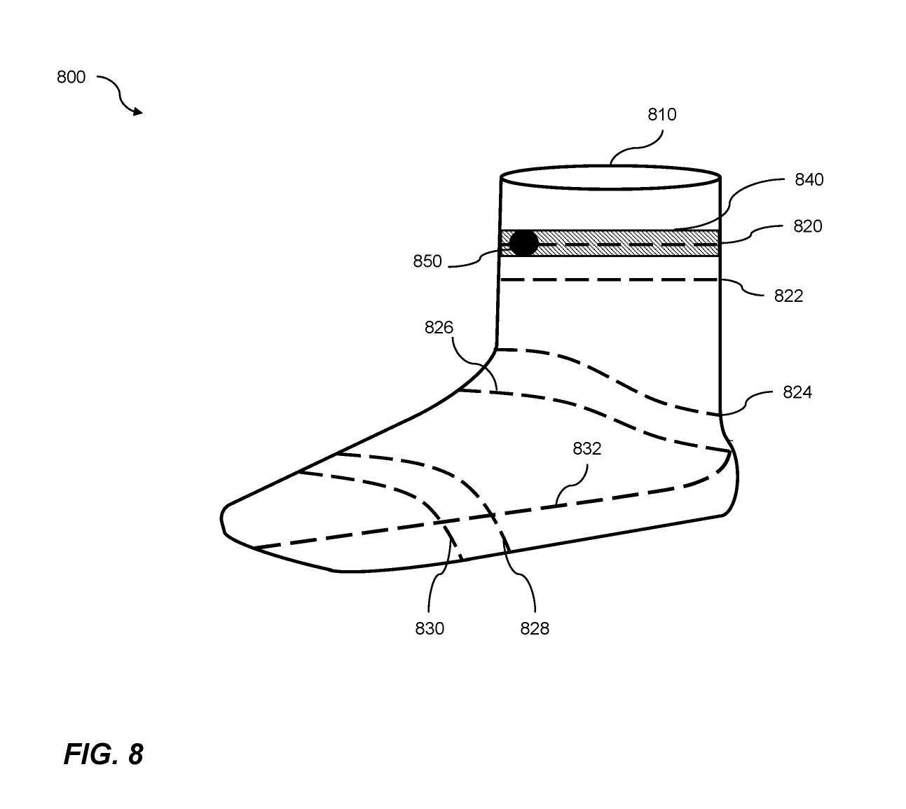

FIG. 8 shows a garment for detecting sizing. A measuring garment 800 includes a plurality of electrically-conductive variable resistance threads, threads 820, 822, 824, 826, 828, 830, and 832, which are integrated within a fabric garment 810. In other embodiments, the threads are electrically-conductive variable capacitance threads. The plurality of electrically-conductive variable resistance threads 820-832 can be woven into the garment, knitted into the garment, or otherwise integrated into the garment using any suitable textile method. A variety of weave types can be used for the fabric garment 810. The weave types can include, but are not limited to, plain weave, twill weave, satin weave, basket weave, leno weave, and mock leno weave. A variety of stitch types can be used for the integration of electrically-conductive variable resistance threads, including, but not limited to, miss stitched, jersey stitches, and tuck stitches. The measuring garment 800 is a sock adapted for measuring foot size. The electrically-conductive variable resistance thread 832 measures a person's foot length, while the other threads measure foot or ankle width. Resistance measurements from each thread are converted to distance measurements, which can then be converted to a high level size such as a shoe size of 8D, 9EE, or the like. While the measuring garment 800 shows a sock for measuring foot size, many other types of measuring garments are possible. The fabric can fit to a form of an individual wherein the form can comprise a foot, an ankle, a calf, a thigh, a torso, a forearm, a hand, a finger, an upper arm, a neck, or a head.

The measuring garment 800 can include a band 840. The band can be a strap, a visual indicator, an alignment mark, or any other object suitable for measurement. The band can be printed on the garment, coupled to the garment, woven into the garment, etc. Data collected from the band can be used to augment the data collected from the electrically-conductive threads of the garment. The data from the band and the data from the electrically-conductive threads can be processed to obtain sizing dimension information. The band or bands can be placed on the garment so as to be aligned with key landmarks of the object being measured, monitored, etc. For example, if the garment were a shirt, the band or bands can be aligned with key landmarks of a body including a shoulder, a wrist, a neck, a chest, and a waist, for example. Other key landmarks can include a knee, an ankle, a thigh, a calf, and so on, and can be included in the gathering of data from the one or more bands and the electrically-conductive threads. The gathering of data can be based on the type of garment or other parameters, for example. Any number of bands can be coupled to the garment. For the garment 800 shown, a band 840 can be coupled to the sock 810. The band can be aligned with the ankle, for example. The band can expand or contract as the garment is worn. The band can be used to obtain sizing dimension information of the part of the object or body on which it is being worn. In the case of the garment 800 shown, the band 840 can expand to determine sizing dimension information of the ankle of the person or object on which the garment is being worn. The band can be used for alignment techniques. In embodiments, a physical coupling device that limits size changes within a portion of the fabric is included. The physical coupling device can be a zipper, a strap, or a button 850 coupled to the fabric. Various other physical coupling devices can be utilized. The physical coupling device can limit stretching in portions of the fabric in order to facilitate stretching in another portion of the fabric. In this manner, a fabric can be used to measure a smaller leg or an arm as well as a larger leg, for example. The strapped, buttoned, or zippered fabric can be constrained as desired by a user. The strap can provide a visual marker for a user to align the fabric with a portion of a body for the user. The strap can provide further sizing information to augment the sizing dimension information. The apparatus can include one or more other straps coupled to the fabric to provide a visual marker for a user to align the fabric with a portion of a body for the user.

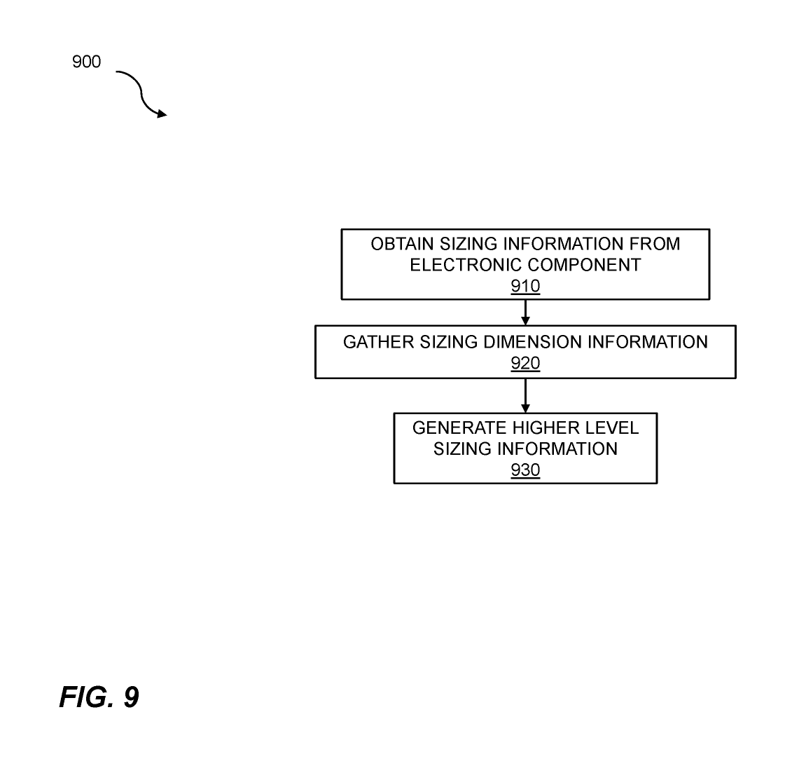

FIG. 9 is a flow diagram for analysis of sizing information. The flow 900 includes obtaining sizing information from an electronic component 910 incorporated with a fabric. In embodiments, this includes measuring resistance values, measuring capacitance values, or measuring a combination of resistance values and capacitance values. The electronic component can comprise: a plurality of flexible electrically-conductive threads that comprise the fabric; insulating threads that can be incorporated with the electrically-conductive threads where the insulating threads can also comprise the fabric and insulate a signal from a first electrically-conductive thread from other threads in the plurality of electrically-conductive threads; and a processing module coupled to the electrically-conductive threads that obtains sizing dimension information using the plurality of electrically-conductive threads.

The flow 900 continues with gathering sizing dimension information 920. At this point, the electrical values measured (capacitance and/or resistance) are converted into size units such as millimeters or inches. This conversion can take place through mathematical formulas and/or lookup tables based on empirical values. In some embodiments, the empirical values are obtained as part of a calibration process. For example, in the case of a measuring garment for hat size, a measuring garment can first be placed on a head model of 21 inches in diameter for the collection of electrical measurements. The garment can then be placed on a head model of 22 inches in diameter, after which additional electrical measurements are collected. This process can be repeated for multiple head model sizes to create a thorough set of empirical data. In some embodiments, the head models are preheated to approximately 90 degrees Fahrenheit to simulate being worn on a human head and to account for any electrical measurement fluctuations as a function of temperature. Continuing with the example of hat size measurement, a plurality of resistance values and corresponding diameters can be collected, as shown in the example table below:

| Distance | | Resistance Value | |
|---|---|---|---|
| 21.125 | inches | 7549.3 | ohms |
| 21.875 | inches | 7954.1 | ohms |
| 22.5 | inches | 9547.2 | ohms |
| 23.875 | inches | 15452.3 | ohms |

While four entries are shown in the table above, in practice there can be many more entries. The relationship between the electrical property and distance can be linear or non-linear. Empirical data captures non-linear behavior. For example, in the table above, the resistance increases more between 22.5 inches and 23.875 inches than between 21.125 inches and 21.875 inches. Interpolation can be used for associating an actual resistance measurement with a distance. The flow 900 continues with generating higher level sizing information 930. The higher level sizing information can include a size. For example, referring to the measurement of hat size, a measurement of 21.8 inches can be associated with a hat size of 7. Various steps in the flow 900 may be changed in order, repeated, omitted, or the like without departing from the disclosed concepts. Various embodiments of the flow 900 may be included in a computer program product embodied in a non-transitory computer readable medium that includes code executable by one or more processors.

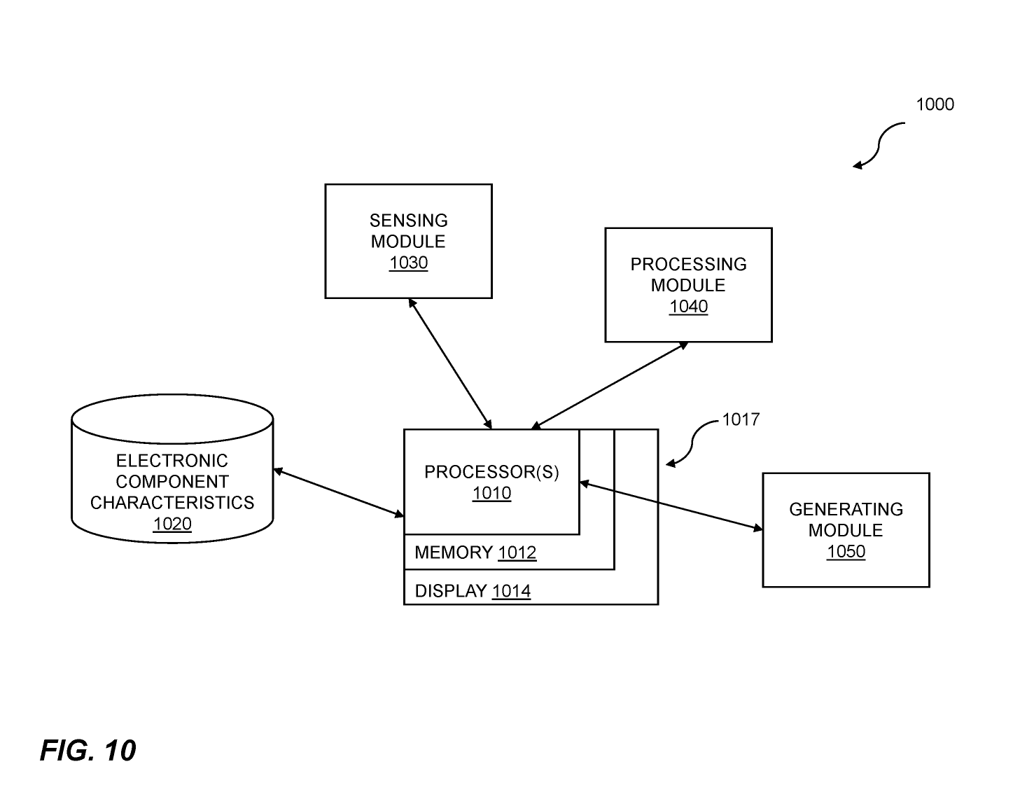

FIG. 10 is a system for analyzing sizing information. The system 1000 can include a sensing module 1030, a processing module 1040, a generating module 1050, an electronic component characteristics module 1020, and an analysis computer 1017. The analysis computer 1017 can comprise one or more processors 1010, a memory 1012 coupled to the one or more processors 1010, and a display 1014 configured and disposed to present user interface information. The electronic component characteristics module 1020 can include a database and/or lookup table including empirically derived values, and can also include calibration data. The processing module 1040 can comprise one or more processors, a battery coupled to the one or more processors, and a communication device. The sensing module can include resistance and/or capacitance measuring hardware and can include hardware for measuring current, voltage, resistance, capacitance, and/or inductance. The generating module 1050 can include hardware for generating direct current and/or alternating current signals used for obtaining resistance and/or capacitance measurements. Typically, the current values are low (e.g. microamperes) and in embodiments, the frequency range includes signals from about 100 hertz to about 1 megahertz.

The system 1000 can include a computer program product embodied in a non-transitory computer readable medium for measurement, the computer program product comprising code which causes one or more processors to perform operations of: obtaining sizing information from an electronic component incorporated with a fabric wherein: the electronic component can comprise a plurality of flexible electrically-conductive threads that comprise the fabric; insulating threads that are incorporated with the electrically-conductive threads where the insulating threads also comprise the fabric and insulate a signal from a first electrically-conductive thread from other threads in the plurality of electrically-conductive threads; and a processing module 1040 that can be coupled to the electrically-conductive threads that obtains sizing dimension information using the plurality of electrically-conductive threads; and gathering the sizing dimension information to generate higher level sizing information.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. An apparatus for measurement comprising:
an electronic component incorporated with a fabric, where the electronic component includes a plurality of flexible electrically-conductive threads that comprise the fabric;
insulating threads incorporated with the flexible electrically-conductive threads wherein the insulating threads also comprise the fabric and insulate a signal from a first electrically-conductive thread, of the plurality of flexible electrically-conductive threads, from other threads in the plurality of flexible electrically-conductive threads; and
a processing module, coupled to the flexible electrically-conductive threads that obtains sizing dimension information using the plurality of flexible electrically-conductive threads.

2. The apparatus of claim 1 wherein the flexible electrically-conductive threads are used to determine the sizing dimension information based on resistance.

3. The apparatus of claim 2 wherein the flexible electrically-conductive threads are stretchable and resistance of the electrically-conductive threads change as the flexible electrically-conductive threads are stretched.

4. The apparatus of claim 2 wherein the flexible electrically-conductive threads are further used to determine the sizing dimension information based on capacitance.

5. The apparatus of claim 1 wherein the flexible electrically-conductive threads are used to determine the sizing dimension information based on capacitance.

6. The apparatus of claim 5 wherein the fabric in between the flexible electrically-conductive threads is stretchable and capacitance changes as the fabric in between the flexible electrically-conductive threads is stretched.

7. The apparatus of claim 5 wherein the flexible electrically-conductive threads are separated into segments and capacitance values are collected from the segments.

8-9. (canceled)

10. The apparatus of claim 1 wherein the sizing dimension information is determined based on stretching of the plurality of flexible electrically-conductive threads.

11. The apparatus of claim 10 wherein the first electrically-conductive thread comprises a first electrically-conductive thread that stretches a first amount.

12. The apparatus of claim 11 wherein the first amount corresponds to a first resistance value.

13. The apparatus of claim 11 further comprising a second resistive thread from the plurality of flexible electrically-conductive threads.

14. The apparatus of claim 13 wherein the second resistive thread stretches a second amount.

15. The apparatus of claim 14 wherein second amount corresponds to a second resistance value.

16. The apparatus of claim 14 wherein the sizing dimension information includes data on the first amount and the second amount.

17-19. (canceled)

20. The apparatus of claim 1 wherein the fabric is stretchable in a single direction.

21. The apparatus of claim 20 wherein the single direction along which the fabric that is stretchable is along an axis containing the plurality of flexible electrically-conductive threads.

22-27. (canceled)

28. The apparatus of claim 1 wherein the processing module is detachable from the fabric.

29. The apparatus of claim 1 wherein the processing module comprises:
one or more processors;
a battery coupled to the one or more processors; and
a communication device.

30-32. (canceled)

33. The apparatus of claim 29 wherein the processing module employs power management and wherein the sizing dimension information is collected during a lower power mode and sizing dimension information is transmitted during a higher power mode.

34. (canceled)

35. The apparatus of claim 1 wherein the fabric comprises a conical tube.

36. The apparatus of claim 35 wherein the conical tube is sized to evaluate a dimension from a person.

37-41. (canceled)

42. The apparatus of claim 1 further comprising a physical coupling device that limits size changes within a portion of the fabric.

43. The apparatus of claim 42 wherein the physical coupling device includes a zipper, a button, or a strap.

44. A computer-implemented method for measurement comprising:
obtaining sizing information from an electronic component incorporated with a fabric wherein:
the electronic component comprises a plurality of flexible electrically-conductive threads that comprise the fabric;
insulating threads are incorporated with the flexible electrically-conductive threads wherein the insulating threads also comprise the fabric and insulate a signal from a first electrically-conductive thread, of the plurality of flexible electrically-conductive threads, from other threads in the plurality of flexible electrically-conductive threads; and
a processing module, is coupled to the flexible electrically-conductive threads that obtains sizing dimension information using the plurality of flexible electrically-conductive threads; and
gathering the sizing dimension information to generate higher level sizing information.

45. A computer program product embodied in a non-transitory computer readable medium for measurement, the computer program product comprising code which causes one or more processors to perform operations of:
obtaining sizing information from an electronic component incorporated with a fabric wherein:
the electronic component comprises a plurality of flexible electrically-conductive threads that comprise the fabric;
insulating threads are incorporated with the flexible electrically-conductive threads wherein the insulating threads also comprise the fabric and insulate a signal from a first electrically-conductive thread, of the plurality of flexible electrically-conductive threads, from other threads in the plurality of flexible electrically-conductive threads; and
a processing module is coupled to the flexible electrically-conductive threads that obtains sizing dimension information using the plurality of flexible electrically-conductive threads; and
gathering the sizing dimension information to generate higher level sizing information.
